(19) United States
(12) Patent Application Publication
(10) Pub. No.: US 2007/0154229 A1
(43) Pub. Date: Jul. 5, 2007

(54) UNIVERSAL DEVELOPER FOR COLOR AND BLACK PRINTING SYSTEMS

(75) Inventors: James A. Winters, Alfred Station, NY (US); Kip L. Jugle, Bloomfield, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/275,406

(22) Filed: Dec. 29, 2005

(51) Int. Cl. G03G 15/08

(52) U.S. Cl. 399/27

(57) ABSTRACT

A method of supplying toner to a printing device includes providing a universal developer for at least two colors. A developer system includes a universal developer unit and a developing station that develops an image using the toner and the universal developer. The universal developer may be provided to each of the colors. An auger for a color mixes the toner and the universal developer supplied therein. The amount of the toner supplied may be determined based on a concentration of the toner and the universal developer in a developer housing. The universal developer may be provided in a form of cartridge, which may be installed to a selected one of the colors.

### BACKGROUND

In a printing machine using toner, such as a color xerographic machine, a developer material is typically provided for each color to be printed. A color-specific developer material is mixed with a respective color of toner in a blender to achieve a homogeneous mixture of developer material and toner in a desired ratio. Such color-specific developers are conventionally installed corresponding color-specific developer housings, for example, a red developer installed into a developer housing printing red toner, and the like.

### SUMMARY

However, this type of developers requires to be provided for a dedicated toner color. Therefore, the cost for manufacturing the developers increases. Moreover, such developers for different colors raise potential errors with the users due to confusion.

In addition, because a developer needs to be provided for each color of toner, an inventory cost for the developer increases, and thus, a large amount of space is required to store the developers.

Therefore, it is an object to provide a universal developer that can be used for any color.

According to various exemplary embodiments, a method for supplying toner to a printing device includes providing a universal developer for at least two colors. Moreover, according to various exemplary embodiments, a developer system includes a universal developer unit including a universal developer for at least two colors.

These and other features and advantages of the disclosed embodiments are described in, or apparent from, the following detailed description of various exemplary embodiments of disclosed systems and methods.

### BRIEF DESCRIPTION OF THE DRAWINGS

Various exemplary embodiments of disclosed systems and methods will be described, in detail, with reference to the following figures, wherein:

FIG. 1 is a diagram showing a printing machine according to an exemplary embodiment of the disclosure;

FIG. 2 is a perspective view of a toner and universal developer supply system according to the exemplary embodiment;

FIG. 3 is a view showing an auger according to the exemplary embodiment;

FIG. 4 is a block diagram showing a controller according to the exemplary embodiment; and

FIG. 5 is a flow chart showing a process of toner supply control according to the exemplary embodiment.

### DETAILED DESCRIPTION OF EMBODIMENTS

In various exemplary embodiments according to the disclosure, a developer includes a universal developer unit having a universal developer, such as carrier, and a developer station for developing an image using the universal developer. Using such a developer system, problems that the conventional developer encounters are overcome. In various exemplary embodiments, the printing machine includes, but not limited to, a printer, copier, fax machine and any other printing device that many be suitable for using the exemplary embodiment according to the disclosure.

While the present disclosure will be described in connection with an exemplary embodiment thereof, it will be understood that it is not intended to limit the disclosure to that embodiment. On the contrary, it is intended to cover all alternatives, modifications, and equivalents as may be included within the spirit and scope of the disclosure as defined by the claims.

First, a structure of an exemplary printing device is described. Here, a black and white printing machine is described as an example. However, as described later, it is appreciated that the universal developer may be used in a multicolor printing machine as well.

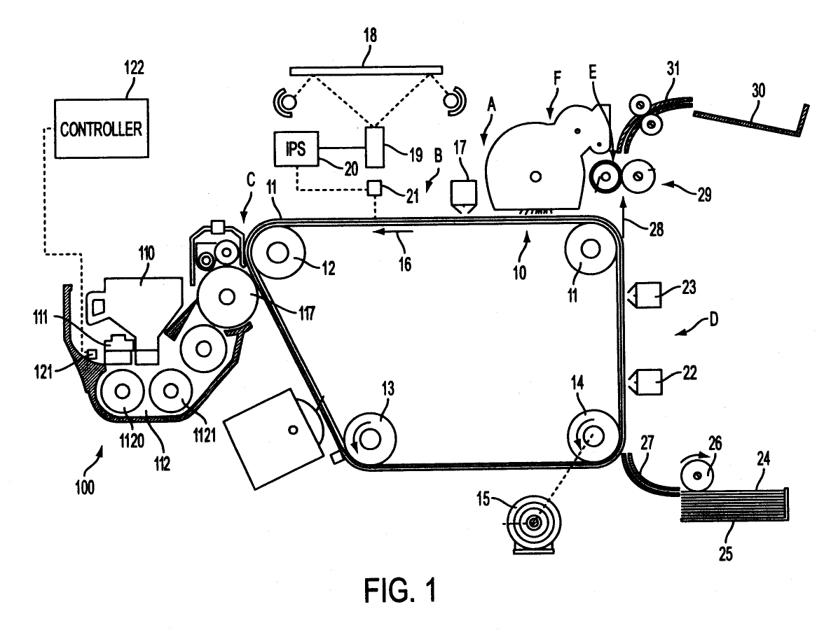

As shown in FIG. 1, an exemplary printing machine may include a photoreceptor belt 10. The photoreceptor belt 10 may be supported by rollers 11, 12, 13, and 14. A motor 15 operates the movement of the roller 14, which in turn causes the movement of the photoreceptor in the direction indicated by an arrow 16, for advancing the photoreceptor sequentially through the various xerographic stations.

A portion of the photoreceptor belt 10 passes through a charging station A where a corona generating device 17 charges the photoconductive surface of the belt 10 to a relatively high, substantially uniform potential. The charged portion of the photoconductive surface is advanced through an imaging and an exposure station B. A document 18 may be positioned on a raster input scanner (RIS) 19. One common type of RIS contains document illumination lamps, optics, a mechanical scanning drive, and a charged coupled device. The RIS captures the entire image from original document 18 and converts it to a series of raster scan lines. Alternatively, image signals may be supplied by an undepicted computer network. This information is transmitted as electrical signals to an image processing system (IPS) 20. The IPS 20 converts image information into signals.

The IPS 20 contains control electronics which prepare and manage the image data flow to a raster output scanning device (ROS) 21, which creates the output copy image. When exposed at the exposure station B, the image areas are discharged to create an electrostatic latent image of the document.

An exemplary developer station C, indicated generally by the reference numeral 100 (hereinafter referred to as a developer 100), advances development material into contact with the electrostatic latent image. The developer 100 may include a developer housing holding toner and a universal developer, i.e., carrier. The toner may be provided in a toner container 110, and the universal developer may be provided a universal developer container 111. The toner container 110 and the universal developer container 111 may be installed on the developer station 100.

The complete universal developer in the universal developer container 111 may be added to the developer housing 100 prior to installing the toner container 110. Once the universal developer has been added to the housing 100, the empty universal developer container 110 may be removed. The toner container 110 may then be installed to the housing 100.

The photoreceptor belt 10 then advances the developed latent image to transfer station D. At the transfer station D, a medium, such as paper, is advanced into contact with the developed latent images on the belt 10. A corona generating device 22 charges the medium to the proper potential so that it becomes tacked to the photoreceptor belt 10 and the toner powder image is attracted from the photoreceptor belt 10 to the medium. After transfer, a corona generator 23 charges the medium to an opposite polarity to detack the medium from the photoreceptor belt 10, whereupon the medium is stripped from the photoreceptor belt 10 at the stripping roller 11.

Sheets of the medium 24 may be advanced to a transfer station D from a supply tray 25. The medium 24 is fed from tray 25, with sheet feeder 26, and advanced to the transfer station D along a conveyor 27. After transfer, the medium 24 continues to move in the direction of an arrow 28 to a fusing station E. The fusing station E may include a fuser assembly 29, which permanently affixes the transfer toner powder images to the medium. Then the medium 24 is ejected to a tray 30 through a path 31.

Residual particles remaining on the photoreceptor belt 10 after each copy is made are removed at a cleaning station F.

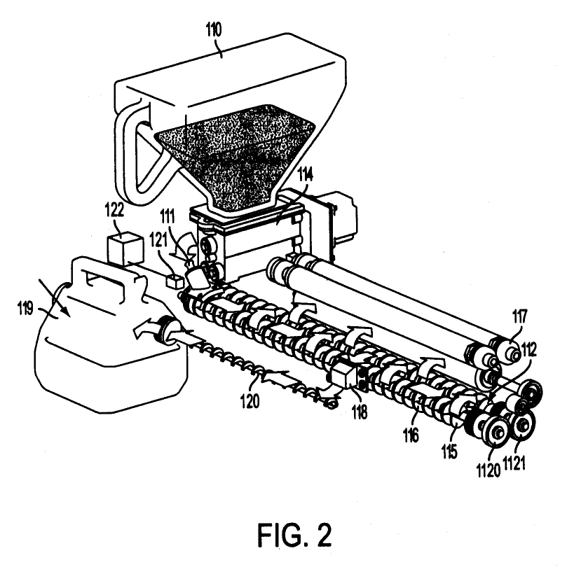

The universal developer according to an exemplary embodiment of the disclosure is described with reference to FIG. 2. As shown in FIG. 2, the toner container 110 contains the toner. In the exemplary embodiment, a black toner is contained in the toner container 110. However, those skilled in the art would appreciate that the toner may be in any color, such as cyan, red, magenta and yellow. If more than one color is processed in the exemplary printing machine, a developer for each color may be provided in a universal developer housing.

According to the exemplary embodiment of the disclosure, the universal developer may include carrier and may be used for any color instead of one dedicated color. That is, the universal developer may be installed into any developer station of a color. In addition, the universal developer is provided in a universal developer unit that may be used in the developer station of any color. Thus, need for a developer material for every color is avoided.

The universal developer may be installed once into the housing and may remain until the life of the developer material has been exceeded. At that time, a new universal developer may be installed in accordance with a developer installation procedure. The toner may then be dispensed into the developer during an initial tone up and then during all printing to maintain the proper toner concentration (TC). When the toner and the universal developer become low, they may be replaced with new toner and universal developer. The level of the toner and the universal developer may be detected by a TC sensor 121. The new toner container 110 may be installed on a toner dispenser 114 that supplies the toner to the augers 112. The amount of the toner supplied may be controlled to adjust the concentration of the toner in the mixed toner and universal developer. Such amount may be determined by the toner concentration detected by the TC sensor 121 to reach a predetermined concentration level based on time interval, specific model type of the printing machine, specific color, and the like, and may be controlled by small increments manually or automatically using an undepicted toner/universal developer dispense motor.

The universal developer container 111 contains the universal developer material, i.e., carrier, to be supplied to the auger 112. The universal developer container 111 may have a universal shape that may be installed in a developer housing of any color, and the universal developer may be used with toner in any color, thus making the container and the carrier universal.

The universal developer may be installed to the housing prior to toner being installed and dispensed. A predetermined weight of the developer may be added all at once to the housing. The weight may be system and color dependent. Once the universal developer has been added to the housing, a predetermined amount of toner may be added to the housing using the dispense system. This may be accomplished by developer install software routines. This predetermined amount may be color and/or system dependent.

The concentration of the toner and the universal developer may be 10:1. Such a predetermined ratio may depend on the color of the toner, a specific type of the toner, a specific model of the printing machine, environments, and the like.

Moreover, the universal developer container 111 may be in a form of a cartridge, which may be a user replaceable cartridge. The cartridge may be installed to the developer station 100. The toner may then be added to the cartridge in the same manner as described above. Because the cartridge is universal for each color, the same universal developer container 111 can be used in any color, and therefore, it may not be necessary to stock a universal developer container for every color used in the printing machine.

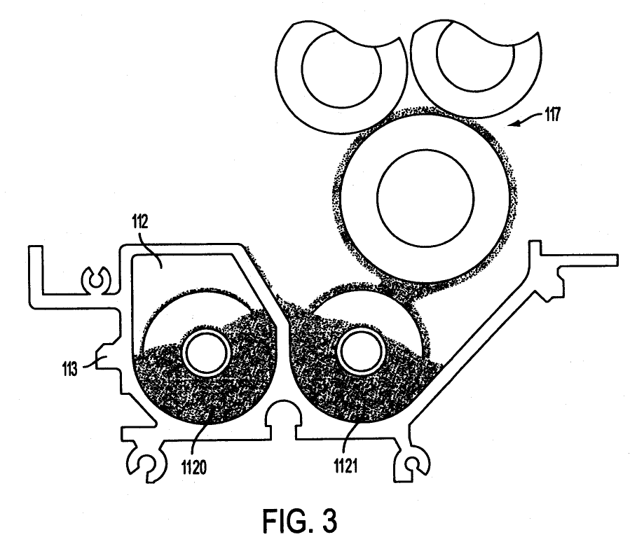

The mixing auger 112 is provided in a developer housing 113 shown in FIG. 3 and is formed of mixing rollers 1120 and 1121. Each of the mixing rollers 1120 and 1121 has spirals 115 thereon. As the mixing rollers 1120 and 1121 rotate in clockwise, for example, in a direction indicated by an arrow 114 shown in FIG. 2, the toner and universal developer are conveyed towards an end of the mixing rollers 1120 and 1121 in a direction indicated by an arrow 116.

As the mixed toner and carrier are transferred to a set of rollers 117, a predetermined amount of the toner is transferred to the belt 11. The universal developer may stay in the housing to be mixed with newly dispensed toner. The carrier component of the universal developer may be provided to help charge the toner to the correct tribo-electric charge as well as forming a transport medium to form a magnetic brush. The toner may be transferred from the magnetic brush to the belt or other subsequent development steps for multi-step development processes.

As the mixing rollers 1120 and 1121 rotate, an excess amount of the mixed toner and the universal developer, which was not used for the actual development of an image, may be collected by a waste developer collector 118 and carried to a removable waste developer container 119 via a spiral on a waste developer roller 120. [The excess amount of the mixed toner and the universal developer may be used in printing systems using replenisher rather than pure toner in the toner container. Replensher may be a toner rich mixture of toner and the universal developer. As toner is dispensed while printing, a small amount of new developer may be added to the older developer to replenish the older developer.

The concentration of the mixed toner and universal developer may be monitored by the TC sensor 121. If the TC sensor 121 determines that the concentration of the universal developer for the supplied amount of the toner, a signal may sent to a controller 122, which may be used to increase the supply of the toner so as to adjust the concentration of the mixture to a predetermined amount. The concentration may be predetermined and color or system dependent.

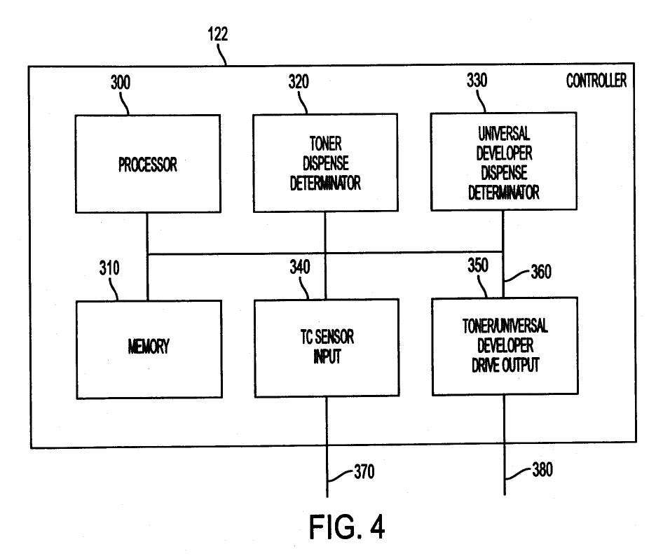

FIG. 4 shows a block diagram of the controller 122. The controller 122 may include a processor 300, a memory 310, a toner dispense determinator 320, a universal developer dispense determinator 330, a TC sensor input 340, and a toner drive output 350, each of which is connected to each other via a bus 360.

The processor 300 controls the general data flow of the data between the memory 310, the toner dispense determinator 320, the universal developer dispense determinator 330, the TC sensor input 340, and the toner drive output 350, and executes a program stored in the memory 310 for controlling the toner dispenser to supply the toner at a predetermined level. The memory 310 may be, in various exemplary embodiments, implemented using static or dynamic RAM. However, the memory 520 may also be implemented using a media, such as a floppy disk and disk drive, a writable or rewritable optical disk and disk drive, a hard drive, flash memory or the like.

The toner dispense determinator 320 determines the amount of the toner to be supplied, based on a signal received from the TC sensor 121. The amount may be a predetermined degree of concentration of the universal developer in the toner, to adjust the concentration of the toner in the mixture.

The universal developer dispense determinator 330 may determine that a new universal developer container is installed. When it determines that a new universal developer container is installed, it may cause the universal developer dispenser to supply the universal developer to the housing. This supply of the universal developer may be accomplished at one time.

The TC sensor input 340 receives a signal transmitted by the TC sensor 121 via a communication line 370, and the toner drive output 350 outputs the result of determination by the toner dispense determinator 320 to a drive unit of the toner r dispenser via a communication line 380 to adjust the amount of the toner supplied so as to adjust the concentration of the toner in the mixed toner and universal developer.

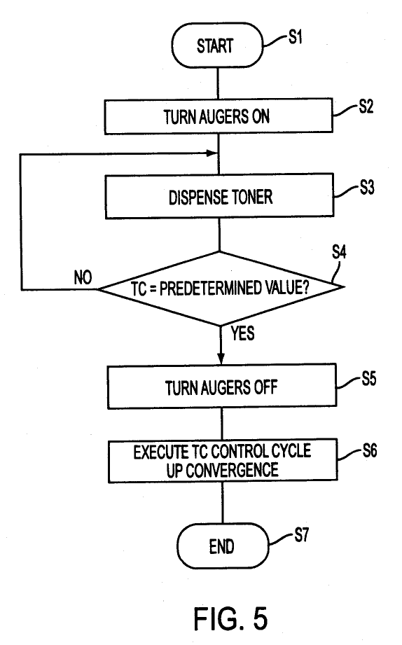

FIG. 5 shows a process flow for controlling the amount of toner supplied to the auger 112 for adjusting the concentration of the toner in the mixed toner and universal developer.

At step S1, the process starts and moves to step S2, at which the rollers 1120 and 1121 of the auger 112 are operated. The rollers 1120 and 1121 may be driven by a common motor or separate motors. At step S3, the toner is dispensed from the toner containers 110, and the process moves to step S4. At step S4, it is determined as to whether a TC value detected by the TC sensor 121 has reached a predetermined value. That is, it is determined based on the TC value as to whether the concentration of the toner in the mixed toner and universal developer has reached a predetermined level. If so, the process moves to step S5, and if not, the process returns to step S3 to continue dispensing the toner until the concentration reaches the predetermined level.

At step S5, the auger 112 is stopped, and the process moves to step S6. At step S6, a TC control cycle is executed. The process ends at step S7.

According to the above-described exemplary embodiment, color developer materials within a product family may be replaced by a single universal developer enabling a cost effective solution to printing machines. Moreover, need for developer blending process for desingnated color coordination may be eliminated, which is a significant cost reduction to manufacturing of the developer material

Moreover, potential errors on the user side may be reduced, and the total inventory of the developers is reduce because the developer material according to the exemplary embodiment may be any color.

It will be appreciated that various of the above-disclosed and other features and functions, or alternatives thereof, may be desirably combined into many other different systems or applications. Also various presently unforeseen or unanticipated alternatives, modifications, variations or improvements therein may be subsequently made by those skilled in the art, and are also intended to be encompassed by the following claims.

What is claimed is:

1. A method of supplying toner to a printing device, comprising:
providing a universal developer for at least two colors.

2. The method according to claim 1, further comprising:
providing a first toner; and
mixing the first toner and the universal developer.

3. The method according to claim 1, further comprising:
providing a second toner; and
mixing the second toner and the universal developer.

4. The method according to claim 2, further comprising:
determining a concentration of a mixture of the toner and the universal developer; and
determining an amount of the first toner to be supplied.

5. The method according to claim 4, wherein the amount of the toner is determined based on a predetermined concentration that depends on at least one of a color of the toner, a time interval, and model information of the printing device.

6. The method according to claim 3, further comprising operating an auger based on the determination of the amount of the first toner.

7. The method according to claim 1, wherein providing the universal developer is selectively installing a universal developer unit in one of at least two universal developer stations for the first and second toner.

8. The method according to claim 1, wherein the universal developer includes carrier.

9. The method according to claim 1, further comprising developing a latent image using the universal developer.

10. A developer system for a printing device, comprising:
a universal developer unit including a universal developer for at least two colors; and
a developer station configured to develop an image using the universal developer.

11. The developer system according to claim 10, further comprising:
a first toner dispenser configured to supply a first toner; and
a first auger configured to mix the first toner and the universal developer.

12. The developer system according to claim 10, further comprising:
a second toner dispenser configured to supply a second toner of a different color than the first toner; and
a second auger configured to mix the second toner and the universal developer.

13. The developer system according to claim 10, further comprising:
a sensor that detects a concentration of the first toner and universal developer in the first auger; and
a controller that includes a toner dispense determiner that determines an amount of the first toner to be supplied to the first auger, based on a detection by the sensor.

14. The developer system according to claim 13, wherein the toner dispense determiner determines the amount of the first toner based on at least one of a color of the toner, time interval, and a model information of the printing device.

15. The developer system according to claim 13, further comprising a toner developer drive output that outputs a signal for operating the first auger based on the determination of the amount of the first toner.

16. The developer system according to claim 10, wherein the universal developer unit is configured for a one-time-installation use.

17. The developer system according to claim 10, wherein the universal developer includes carrier.

18. A xerographic device including the developer system, including a developer system for a printing device, comprising:
a universal developer unit including a universal developer for at least two colors; and
a developer station configured to develop an image using the universal developer.

19. The developer system according to claim 18, further comprising:
a first toner dispenser configured to supply a first toner; and
a first auger configured to mix the first toner and the universal developer.

20. The developer system according to claim 18, further comprising:
a second toner dispenser configured to supply a second toner of a different color than the first toner; and
a second auger configured to mix the second toner and the universal developer.
